(19) United States
(12) Patent Application Publication
(10) Pub. No.: US 2004/0075791 A1
(43) Pub. Date: Apr. 22, 2004

(54) Wide view angle ultra minimal transflective-type vertically aligned liquid crystal display

(76) Inventor: Hong-Da Liu, Chu Pei City (TW)

Correspondence Address: THOMAS T. MOGA, DICKINSON WRIGHT PLLC, 1901 L STREET N.W., SUITE, WASHINGTON, DC, 20036, US

(21) Appl. No.: 10/449,935

(22) Filed: May 30, 2003

(30) Foreign Application Priority Data
Oct. 16, 2002 (TW) 91123863

(51) Int. Cl. G02F 1/1335

(52) U.S. Cl. 349/114; 349/130

(57) ABSTRACT

A transflective-type vertically aligned liquid crystal display (LCD) is described. At least one patterned transmitting opening is formed in an ultra minimal reflective layer. The ultra minimal reflective layer serving as a bottom electrode provides perfect reflective results. The ultra minimal reflective layer has a transflective structure serving as a scattering layer and further eliminates the fabrication steps to reduce manufacturing costs. The patterned bottom electrode corresponding to a top patterned transparent electrode divides the display unit into several domains to form a multi-domain structure. By employing a vertically aligned liquid crystal display with the multi-domain structure, a wide-viewing angle for the liquid crystal display is provided.

### FIELD OF THE INVENTION

The present invention relates to a liquid crystal device, and more particularly, the present invention relates to a transflective-type liquid crystal display.

### BACKGROUND OF THE INVENTION

Liquid crystal displays (LCD) are widely applied in electrical products, such as digital watches, calculators, and the like. Moreover, with advances in techniques for manufacture and design, thin film transistors liquid crystal display (TFT-LCD), has been introduced into portable computers, personal digital assistants, color televisions, and gradually replaced conventional cathode ray tube displays. Transmission LCDs have been the main development in the field. Generally, a light source, called a back light, of a transmission LCD is located behind the display. Hence, the material used for the pixel electrodes has to be a transparent conductive material such as indium tin oxide (ITO). The back light of a transmission LCD is the most power-consuming part. However, the widest application of LCD is portable computers and communication products. Batteries are the main power supply during use of these devices. Therefore, the main question in LCD product development has been how to decrease LCD power consumption. Moreover, reflection from the transmission LCD when used in a bright environment reduces contrast, resulting in an unclear image.

A reflective LCD is one solution to the problem mentioned above. The light source of a reflective LCD is located outside the LCD; therefore, a reflective layer is needed to reflect the light. Conventionally, the pixel electrode is used as the reflective layer. The material used for the pixel electrodes has to be a reflective conductive material such as metal aluminum. For achieving a better reflective result, the surface of the pixel electrodes is uneven. However, the reflective LCD still has a problem in that an insufficient intensity of light from the outside light source means that the reflective LCD cannot display a clear image. Therefore, the transflective LCD has become the next target of research and development. The pixel electrodes of some transflective LCDs are aluminum plates having at least one opening filled with ITO. Therefore, when outside light intensity is not strong enough, the back light can be turned on to serve as a light source.

A twisted-nematic (TN) cell of single domain structure is widely used in conventional liquid crystal displays. In recent years, the transflective LCDs have used a cross-polarizers and the compensating layer outside the LCD panel, such as the reflective twisted nematic liquid crystal display (RTN LCD) and mixed mode twisted nematic liquid crystal display (mixed mode TN-LCD). However, there is an inherent problem in the viewing angle of the transflective LCDs. Further, the contrast is only in the range of from 15:1 to 50:1. The narrow viewing angle and the low contrast limits the development. The rubbing process for manufacturing the transflective LCDs further complicates the problems of ESD protection and particle pollution.

A height difference of about 0.5 μm to 1.5 μm exists in the conventionally used reflective layer. The height difference changes the liquid crystal (LC) cell gap. The reflective efficiency is related to the retadation (R) of the LC cell. The retadation (R) of the LC cell is related to the change value (Δd) of the cell gap and the birefringence (A n) of the LC. Typically, the birefringence Δn of the LC is in the range of about 0.06 to 0.1. Therefore, the change value Δnd is in the range of about 0.06 μm to 0.15 μm (Δndⱼ to Δndᵢ) if the change value (Δd) of the cell gap is in the range of about 0.5 μm to 1.5 μm. Such change value Δnd reduces the reflective efficiency from 100% to 60%. The low reflective efficiency cannot sufficiently reflect ambient light to make a clear image. Therefore, it is difficult to use the conventional transflective LCD in portable displays for devices such as mobile phones, personal digital assistants (PDA), mobile computers and so on. Moreover, how to reduce the power consumption and reflection are also problems to be resolved.

### SUMMARY OF THE INVENTION

The main purpose of the present invention is to use a reflective layer in a transflective-type vertically aligned liquid crystal display. The reflective layer is used as the bottom electrode and the scattering layer, directly increasing the reflective efficiency, which reduces the fabricating steps and the cost.

Another purpose of the present invention is to provide an electrode design for the transflective-type vertically aligned liquid crystal display. In accordance with the electrode design, the patterned electrode corresponding to the top electrode divides the display unit into several domains to provide a wide viewing angle.

A further purpose of the present invention is to provide a bump layer over the pixel electrode for the transflective-type vertically aligned liquid crystal display. The bump structure provides a pre-tilt angle for the LC molecules. The pre-tilt angle ensures that the LC molecules tilt in the desired direction when a voltage is applied to the LCD to obtain a wide viewing angle.

Another purpose of the present invention is to form a minimal or ultra-minimal reflective layer for the transflective-type vertically aligned liquid crystal display. The minimal or ultra-minimal reflective layer increases the reflective efficiency. Such a high reflective efficiency increases the usage of the environment light and reduces the power consumption of the back light.

The present invention provides a transflective-type vertically aligned liquid crystal display. The liquid crystal display comprises two substrates and a vertically aligned liquid crystal layer sandwiched between the two substrates. A rough layer is formed in an inner surface of one of the two substrates. A conductive reflective layer is formed on and conforms to the surface of the rough layer. Therefore, the conductive reflective layer also has a rough surface. On the other hand, a first electrode opening is formed in the conductive reflective layer to divide the conductive reflective layer into several domains. A transparent conductive layer is formed on the inner surface of another substrate. A second electrode opening is formed in the transparent conductive layer. The second electrode opening alternatively corresponds to the first electrode opening. A bump layer is also formed over the rough layer to provide a pre-tilt angle for the vertically aligned liquid crystal molecules.

The liquid crystal display of the present invention uses the conductive reflective layer as the scattering layer and the bottom electrode, which increases the reflective efficiency and simplifies the manufacturing process to reduce the cost. On the other hand, the electrode opening pattern formed in the conductive reflective layer divides the bottom electrode into several domains. Such a pattern not only is used as the opening of the transmitting region of the LCDs but also provides a multi-domain structure to increase the viewing angle of the LCD.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic, cross-sectional drawing of a liquid crystal display unit in accordance with the present invention;

FIG. 2A is a schematic, top view of a bottom substrate of a liquid crystal display unit in accordance with the present invention;

FIG. 2B is a schematic, top view of a top substrate of a liquid crystal display unit in accordance with the present invention;

FIG. 3 is a schematic, cross-sectional drawing of an ultra-minimal reflective layer in accordance with the present invention;

FIG. 4 is a structure schematic drawing of the bottom substrate of the FIG. 2A overlapping the top substrate of FIG. 2B in accordance with the present invention;

FIG. 5 is a schematic, cross-sectional drawing of a liquid crystal display unit in accordance with the present invention;

FIG. 6 is a schematic, cross-sectional drawing of a liquid crystal display unit in accordance with the present invention;

FIG. 7A is a schematic, top view of a bottom substrate of a liquid crystal display unit in accordance with the present invention;

FIG. 7B is a schematic, top view of a top substrate of a liquid crystal display unit in accordance with the present invention;

FIG. 8 is a schematic, cross-sectional drawing of a liquid crystal display unit in accordance with the present invention;

FIG. 9 is a schematic, top view of a liquid crystal display unit in accordance with the present invention.

FIG. 10 is a schematic, top view of a liquid crystal display unit in accordance with the present invention;

FIG. 11A to FIG. 11D is a schematic, top view of an electrode opening in accordance with the embodiments of the present invention;

FIG. 12 is a schematic, cross-sectional view of an ultra minimal reflective layer and the P-type low temperature polysilicon thin film transistor; and

FIG. 13 is a schematic, cross-sectional view of an ultra minimal reflective layer and the complementary-type low temperature polysilicon thin film transistor.

### DETAILED DESCRIPTION OF THE PREFERRED EMBODIMENT

The present invention provides a transflective-type vertically aligned liquid crystal display. A reflective layer is used in the present invention as the bottom electrode and an electrode opening pattern is formed in the reflective layer. This pattern and the corresponding top transparent electrode are used to divide the display unit into several domains to form a multi-domain structure. This multi-domain structure provides a wide-viewing angle. Moreover, a bump layer is also used in the present invention to provide a pre-tilt angle for the liquid crystal molecules, which further provides the viewing angle. Moreover, the present invention uses the ultra-minimal reflective layer. The ultra-minimal reflective layer increases the reflective efficiency. Such high reflective efficiency increases the usage of ambient light and reduces the power consumption of the back light.

Without limiting the spirit and scope of the present invention, the structure proposed in the present invention is illustrated with one preferred embodiment. Skilled artisans, upon acknowledging the embodiments, can apply the present invention to any kind of liquid crystal display. The usage of the present invention is not limited by the embodiments as follows.

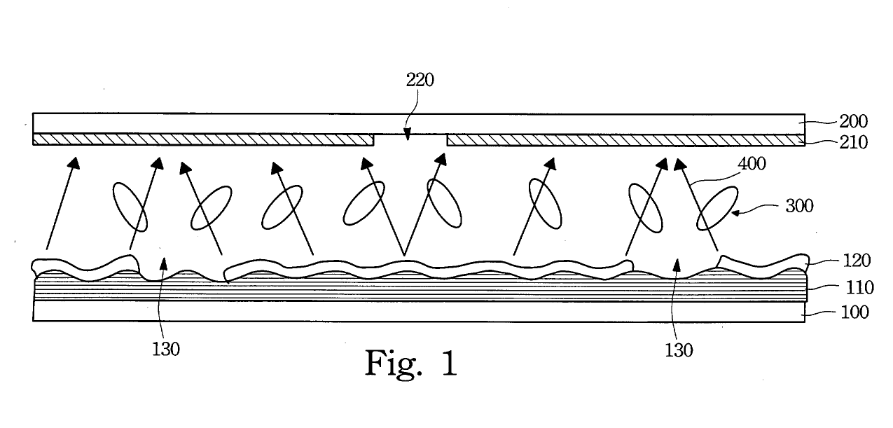

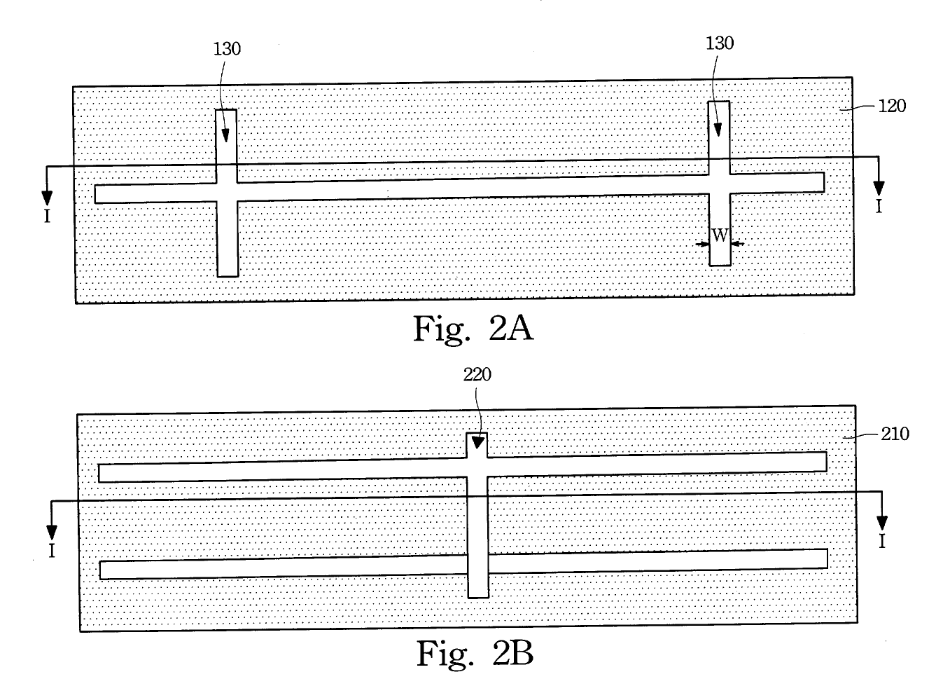

FIG. 1 is a schematic, cross-sectional drawing of a liquid crystal display unit in accordance with the present invention. FIGS. 2A and 2B, respectively, are the schematic, top view of a bottom substrate and a top substrate of a liquid crystal display unit in accordance with the present invention. The cross-sectional drawing of FIG. 1 corresponds to the cross section line I-I of FIG. 2A and the cross section line I′-I′ of FIG. 2B. The liquid crystal display of the present invention comprises a bottom transparent substrate 100 and a top transparent substrate 200. Typically, the material for forming the bottom transparent substrate 100 and the top transparent substrate 200 is glass. A thin film transistor (not shown in the figure) is built in a pixel unit of the bottom transparent substrate 100 to control the pixel unit. A thin film transistor comprising amorphous silicon thin film transistor or polysilicon thin film transistor may be used. The polysilicon thin film transistor comprises a P-type or a complementary low temperature polysilicon thin film transistor.

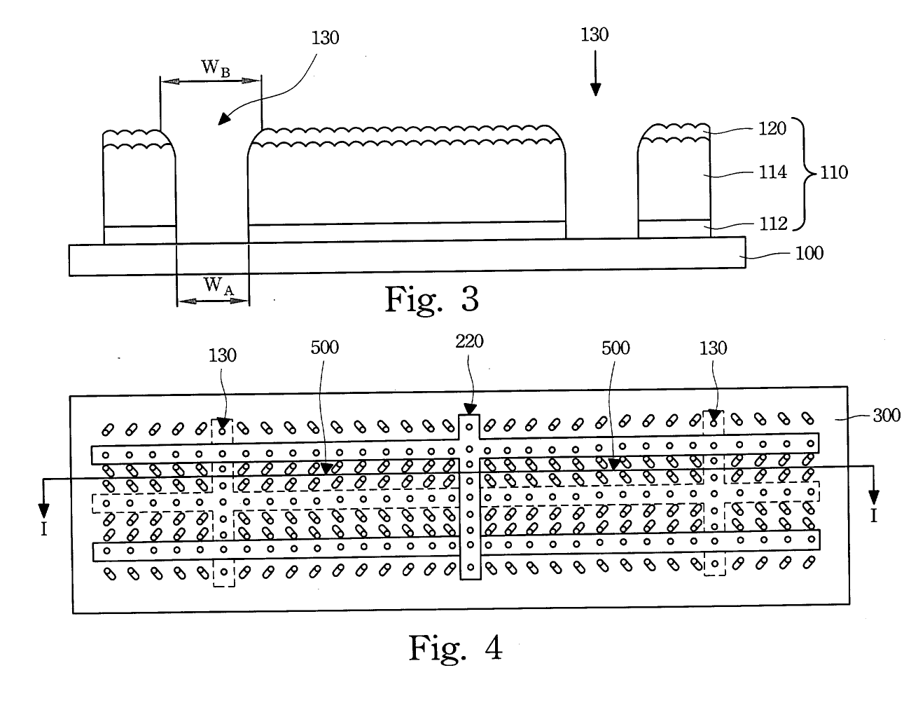

Next, a rough layer 110 is formed over the bottom transparent substrate 100. The manufacturing of the rough layer 110 is integrated into the fabricating process of the thin film transistor. There are many methods of forming the rough layer. Typically, the rough layer 110 is formed over the pixel electrode after the thin film transistor is finished. The present invention uses the technology described in the following to form an ultra-minimal rough layer with an ultra-minimal rough surface. This ultra-minimal rough layer provides an improved reflective efficiency. Reference is made to FIG. 3; a polycrystalline or an amorphous indium tin oxide layer 112 (a-ITO) is formed over the bottom transparent substrate 100. The a-ITO 112 is formed, for example, by CVD using indium oxide and stannic oxide. The indium tin oxide layer is controlled to form an amorphous crystal structure by conditions control during the process.

Next, a silicon-containing rough layer 114 is formed over the a-ITO layer 112. The material of the silicon-containing rough layer 114 is amorphous silicon, polysilicon, SiNₓ, SiOₓ or SiONₓ. Typically, the silicon-containing rough layer 114 is formed by CVD. The crystal structure of the a-ITO layer 112 is extended to the silicon-containing rough layer 114 and results in the rippled surface of the silicon-containing rough layer 114. It is very important to control the level of the rough layer 14 while forming the silicon-containing rough layer 114. The size of the protruding grain in the ripple surface of the silicon-containing rough layer 114 is controlled by changing the process conditions. The average length L of the protruding grain is about 10 nm to 500 nm, and the height H is about 5 nm to 100 nm. The sharp angle of the protruding grain is about 3 degrees to 65 degrees. Then, the ultra minimal rough layer is formed to serve as the rough layer 110 of the present invention. An inorganic method is used to form the above thin film. Such thin film formed by an inorganic method can be used in a higher process temperature than thin films formed by the organic method.

On the other hand, the a-ITO layer 112 can also be replaced with a seed layer having a scattered crystal structure, made from, for example, amorphous silicon, polysilicon, SiNₓ (silicon nitride), SiOₓ (silicon nitride) or SiONₓ (silicon oxynitrides). Then, a silicon-containing rough layer 114 is formed over the seed layer. The crystal structure of the silicon-containing rough layer 114 is affected by the seed layer to form the ultra minimal rough surface. Typically, the process method is CVD if amorphous silicon or polysilicon is selected to form the silicon-containing rough layer 114. The degree of roughness in the surface of the silicon-containing rough layer 114 can be modified by controlling the grain size by a thermal process, a laser crystallized process or a removing hydrogenation process. Moreover, a sputtering process using the silicon target also can be used to form a silicon layer with a minimal crystalline grain to serve as the silicon-containing rough layer 114.

A conductive reflective layer 120 is formed over the rough layer 110 to serve as a conductive electrode. The process steps can be reduced because the process steps for forming the conductive reflective layer 120 and the rough layer 110 can be integrated into the thin film transistor process, which reduces the process cost. The reflective layer 120 is formed from a material having an excellent reflective characteristic, such as aluminum, silver, an alloy of aluminum and silver, or a conductive reflective multi-layer. Moreover, the reflective layer 120 also can be formed from a metal layer with partial transparency in the bottom or the reflective multi-layer. Such layer not only reflects light from the outside but also transmits the light from the back-light source. The reflective layer 120 is formed to conform to the rough layer 110. Therefore, a rippled surface the same as the rough layer 110 is formed on the reflective layer 120. The sharp angle of the protruding grain of the reflective layer 120 is about 2 degrees to 15 degrees and the preferred sharp angle is about 7 degrees to 12 degrees. An excellent reflective efficiency is obtained in the range of the sharp angle. An electrode opening pattern 130 is formed in the reflective layer 120. In this embodiment, the opening pattern 130 is similar to a double cross pattern as shown in FIG. 2A. The width W in the electrode opening pattern 130 must be modified according to the size of the pixel. The width W is about 1 μm to 15 μm. The ratio of the cell gap d between the substrate 100 and 200 to the width W is about 0.1 to 6. The opening pattern 130 can only be formed in the reflective layer 120 as shown in FIG. 1 or be formed to expose the bottom substrate 100 as shown in FIG. 3. The width WB in the top of the opening pattern 130 is about 0.85 to 1.15 times the width WA in the bottom of the opening pattern 130.

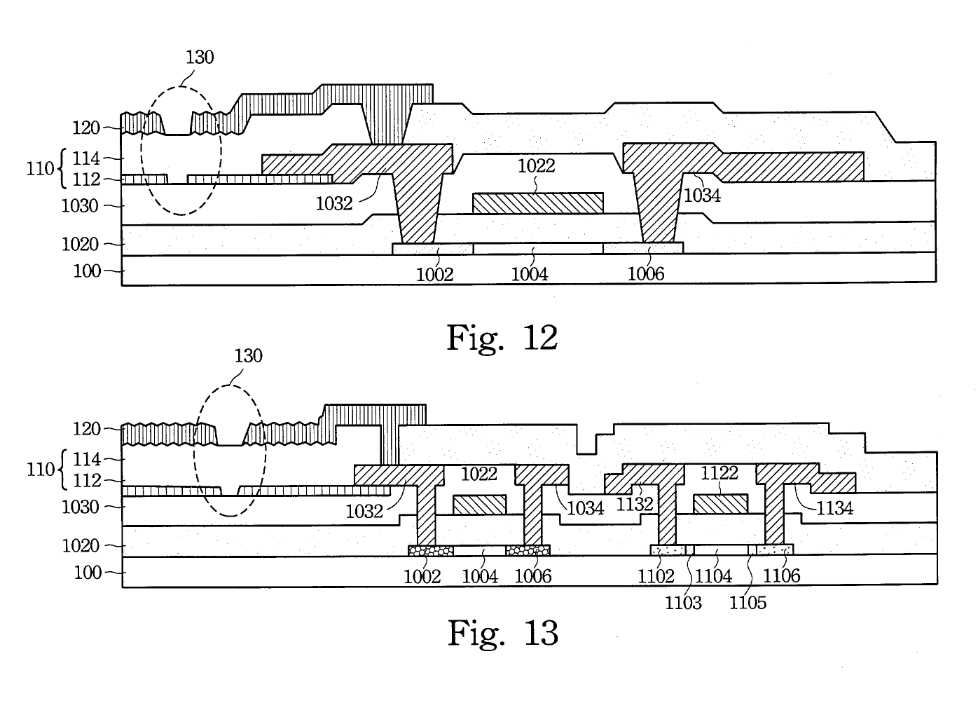

The following is a detailed description of the ultra minimal reflective layer respectively formed in the P-type low temperature polysilicon thin film transistor and in the complementary-type low temperature polysilicon thin film transistor. FIG. 12 is a schematic, cross-sectional view of an ultra minimal reflective layer and the -type low temperature polysilicon thin film transistor. The P-type low temperature polysilicon thin film transistor is formed on the substrate 100. The P-type low temperature polysilicon thin film transistor shown in the FIG. 12 includes the P-type doped source region 1002, the P-type doped drain region 1006 and the low temperature polysilicon channel 1004. Then, a dielectric layer 1020 covers the source region 1002, the drain region 1006 and the channel 1004. A gate electrode 1022 is formed over the dielectric layer 1020 and aligned to the low temperature polysilicon channel 1004. The low temperature polysilicon thin film transistor comprises dielectric layer 1020, the source region 1002, the drain region 1006, the channel 1004 and the gate electrode 1022. A dielectric passivation layer 1030 is formed over the gate electrode 1022. An a-ITO layer 112 is formed on the pixel region. An electrode opening pattern 130 is formed in the a-ITO layer 112. Next, the source region 1002 and the drain region 1006 are respectively connected with the conductive line 1032 and 1034 in the passivation 1030 through the plugs. The conductive line 1032 can be connected to the a-ITO layer 112 selectively to improve the electric field. A silicon-containing rough layer 114 covers the whole substrate 100. The silicon-containing rough layer 114 over the a-ITO layer 112 forms the ultra minimal rough surface. Finally, a conductive reflective layer 120 is formed over the silicon-containing rough layer 114 in the pixel region. The conductive reflective layer 120 is connected to the conductive line 1032 through the plug to serve as the pixel electrode and an electrode opening 130 is formed herein. On the other hand, the electrode opening 130 can also be etched from the conductive layer 120 to the bottom to explode the a-ITO layer 112 as shown in the FIG. 3.

On the other hand, the fabrication method of the complementary-type low temperature polysilicon thin film transistor is similar to the fabrication method of the P-type low temperature polysilicon thin film transistor. However, an N-type low temperature polysilicon thin film transistor is also formed during the complementary-type low temperature polysilicon thin film transistor fabricating process. FIG. 13 is a schematic, cross-sectional view of an ultra minimal reflective layer and the complementary-type low temperature polysilicon thin film transistor. Referring to FIG. 13, an N-type low temperature polysilicon thin film transistor is formed near the P-type low temperature polysilicon thin film transistor to form the complementary-type low temperature polysilicon thin film transistor. The N-type low temperature polysilicon thin film transistor includes the N-type doped source region 1102, the N-type doped drain region 1106 and the low temperature polysilicon channel 1104 between the source and drain region. The N-type doped region 1103 is formed between the N-type doped source region 1102 and the low temperature polysilicon channel 1104. The N-type doped region 1105 is formed between the N-type doped drain region 1106 and the low temperature polysilicon channel 1104. The gate electrode 1122 is formed over the dielectric layer 1020 and aligned to the low temperature polysilicon channel 1104.

On the other hand, a transparent conductive layer 210 is formed on the inner surface of the top substrate 200 to serve as the top electrode. Typically, ITO or IZO material is used to form the transparent conductive layer 210. An electrode opening 220 is also formed in the transparent conductive layer 210. The pattern of the electrode opening 220 corresponds to the pattern of the electrode opening 130. Moreover, the pattern of the electrode opening 220 and the electrode opening 130 alternate with each other to divide the display unit into multiple regions and form multi-domain structure. Finally, a vertically aligned liquid crystal molecule is disposed between the top substrate 100 and the bottom substrate 200 to form a liquid crystal layer 300. This liquid crystal molecule is a negative liquid crystal molecule (Δε<0) with birefringent Δn. The birefringent Δn is about 0.05 to 0.15. This liquid crystal molecule is preferably Chiral or doped with Chiral liquid crystal molecule. The natural pitch of the liquid crystal molecule is larger than about 20 μm.

FIG. 4 is a structural schematic drawing of the bottom substrate of the FIG. 2A overlapping the top substrate of the FIG. 2B in accordance with the present invention. The top electrode and the bottom electrode (the transparent conductive layer 210 and the conductive reflective layer 120) alternate with each other. The multi-domain structure generates an alignment electric field 400 between the top electrode and the bottom electrode when a voltage is applied. The alignment electric field 400 twists the liquid crystal molecule of the liquid crystal layer 300 to control the light passing through the liquid crystal layer 300. It is not necessary to use the rubbing process in the multi-domain structure. Moreover, the multi-domain structure improves the average angle of the light passing through the top substrate 200 to improve the viewing angle.

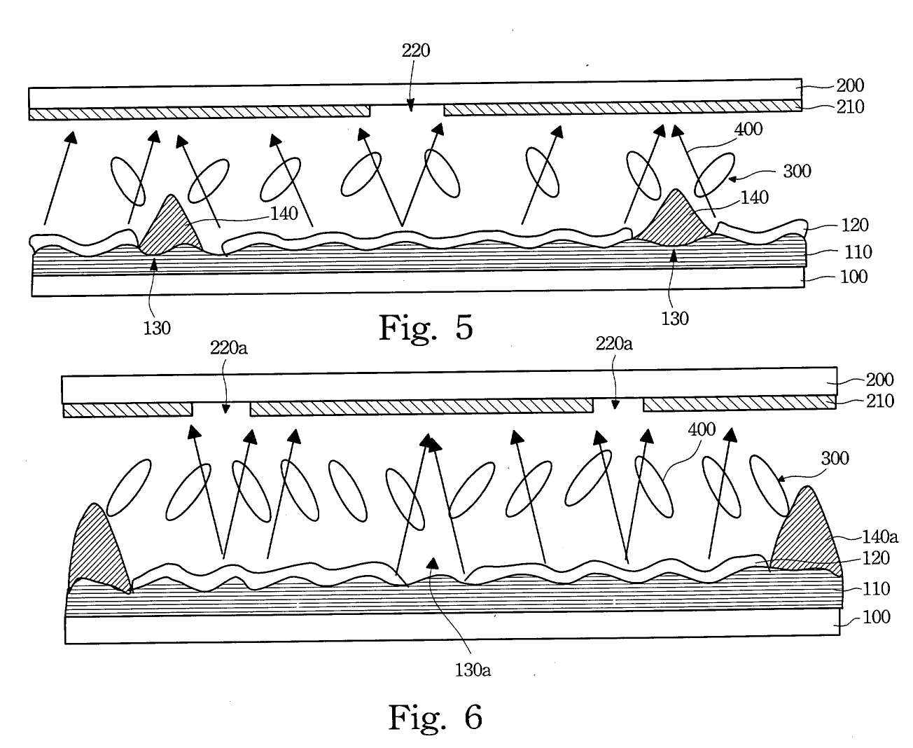

FIG. 5 is a schematic, cross-sectional drawing of a liquid crystal display unit in accordance with the present invention. Referring to FIG. 5, a bump layer 140 is formed over the pattern of the electrode opening 130. The bump layer 140 ridges from the rough layer 110. The sharp angle is about 10 degrees to 85 degrees. The bump layer 140 improves the pre-tilt angle of the liquid crystal molecule near the bump layer 140 in the liquid crystal layer 300. This pre-tilt angle provides a wide viewing angle to improve the image. The bump layer 140 replaces the conventional rubbing technology and reduces particle pollution. A photoresist can be used to form the bump layer 140 in a photolithography process. The rough layer 110 under the bump layer 140 and the bump layer 140 can be formed in one step if both are formed using the same photoresist material.

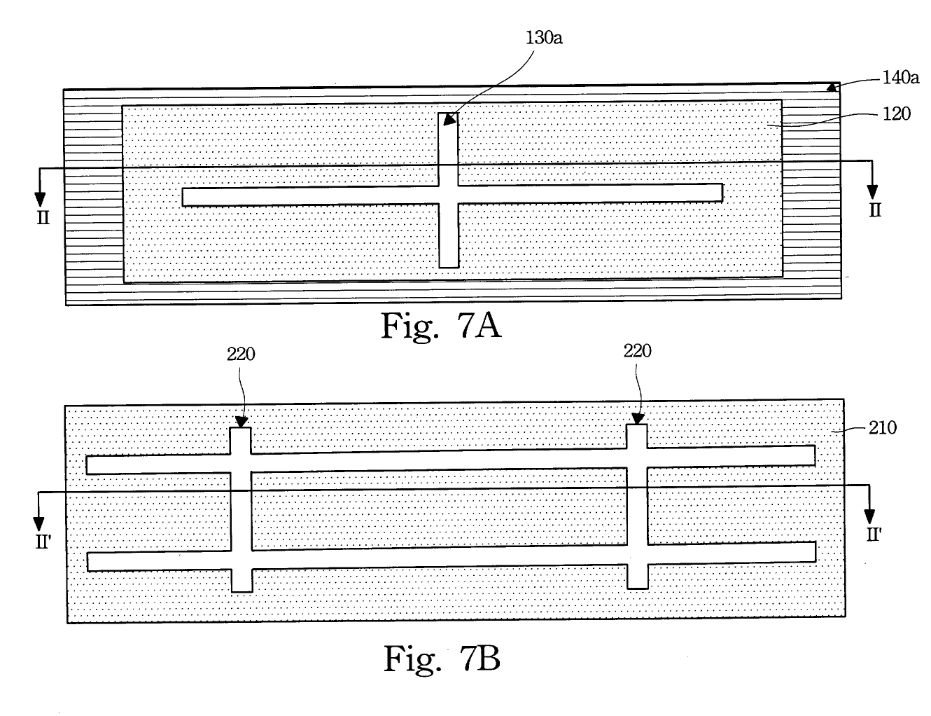

In addition to the above embodiment, the present invention also provides another embodiment. FIG. 6 is a schematic, cross-sectional drawing of a liquid crystal display unit in accordance with the present invention. FIG. 7A is a schematic, top view of a bottom substrate of a liquid crystal display unit in accordance with the present invention. FIG. 7B is a schematic, top view of a top substrate of a liquid crystal display unit in accordance with the present invention. The cross-sectional drawing of FIG. 6 is respectively viewed along line II-II in FIG. 7A and line II′-11′ in FIG. 7B. Referring to FIG. 6, FIG. 7A and FIG. 7B together, the description of the same number refers to the above description. In this embodiment, the pattern of the electrode opening is similar to the cross pattern. The branch of this cross pattern is either perpendicular to or parallel to the boundary of the pixel region to form the opening pattern 130a. Similarly, the opening pattern 220a in the transparent conductive layer 210 also needs to be changed according to the corresponding opening pattern 130a to provide the multi-domain structure.

A bump layer is also formed over the rough layer 110. In this embodiment, the bump layer 140a is formed in the boundary of the display unit to improve the pre-tilt angle of the liquid crystal molecule in the boundary of the liquid crystal layer 300. Similarly, the bump layer also is formed in the opening pattern 130a to provide the pre-tilt angle to the liquid crystal molecule to improve the viewing angle.

Yet another embodiment is provided. A partial opening is formed in the conductive reflective layer. A transparent electrode is formed in the opening to modify the ratio of the reflective region to the transmitting region. This embodiment improves the design convenience. The retadation Δnx d_{T} of the liquid crystal cell in the transmitting region is preferably about 150 nm to 500 nm. On the other hand, the retadation Δnx d_{R} of the liquid crystal cell in the reflective region is preferably about 150 nm to 420 nm.

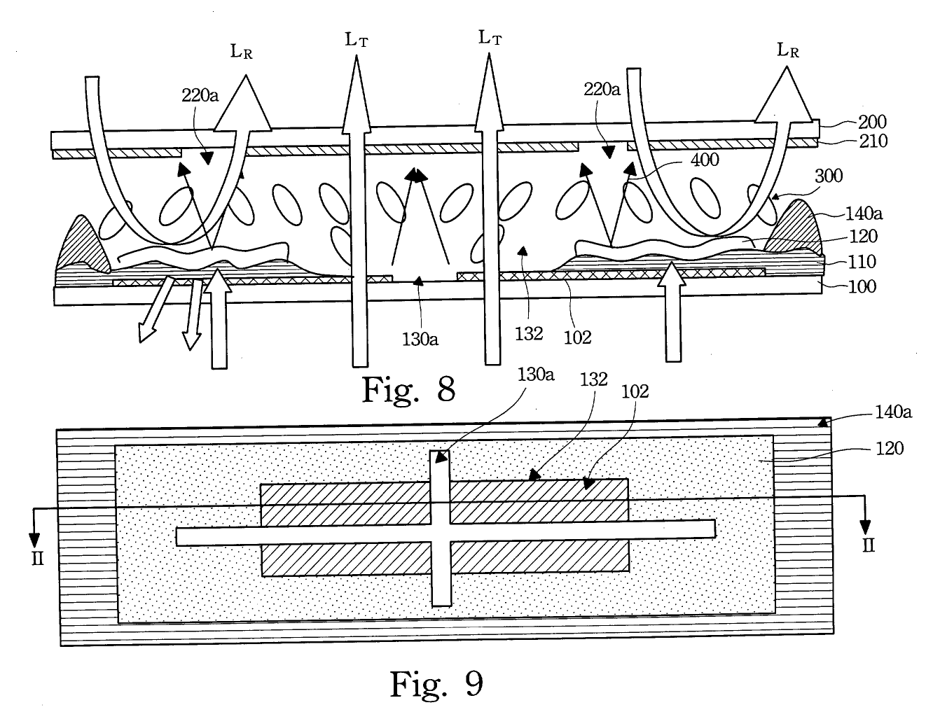

FIG. 8 is a schematic, cross-sectional drawing of a liquid crystal display unit in accordance with the present invention. FIG. 9 is a schematic, top view of a liquid crystal display unit in accordance with the present invention. The cross-sectional drawing of FIG. 8 is from the line III-III in FIG. 9. Referring to FIGS. 8 and 9 together, the description of the same number is referred to in the above description. In the embodiment, a transmitting opening 132 is additionally formed in the reflective layer 120 to modify the ratio of the reflective region to the transmitting region. A little change compared with the above description also exists in the structure. First, a transparent conductive layer 102 is formed over the bottom substrate 100. The material of the transparent conductive layer 102 is ITO or IZO. Next, the opening pattern 130a is formed in the transparent conductive layer 102. Then, a rough layer 110 and the conductive reflective layer 120 are formed over the transparent conductive layer 102 sequentially. A transmitting opening 132 overlapping opening pattern 130a is formed in the rough layer 110 and the conductive reflective layer 120. The overlapped region is transparent to light. The pattern of the transmitting opening 132 is rectangular as shown in the FIG. 9. Additionally, the location of the transparent conductive layer 102 is changed and is formed between the rough layer 110 and the reflective layer 120. Such change of the transmitting region including the opening pattern 130a and the transmitting opening 132 improves the transmitting light L_{T} in the transmitting region. The design convenience also is improved by modifying the ratio of the transmitting light L_{T} to reflective light L_{R}.

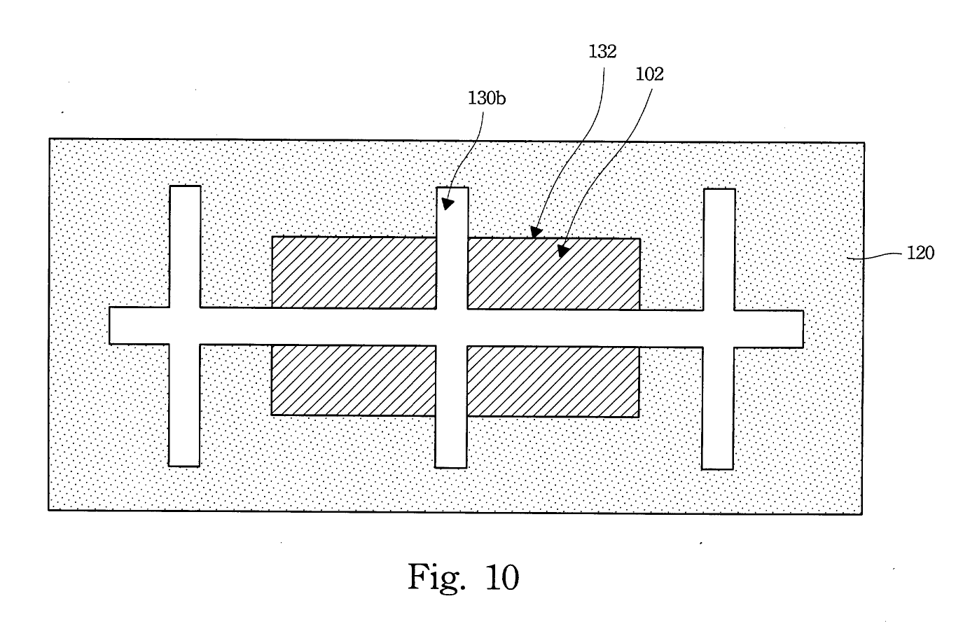

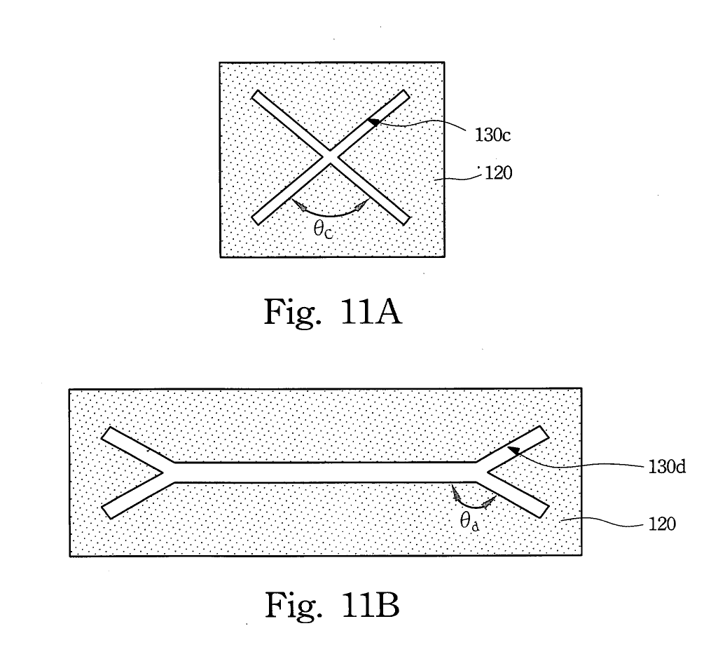

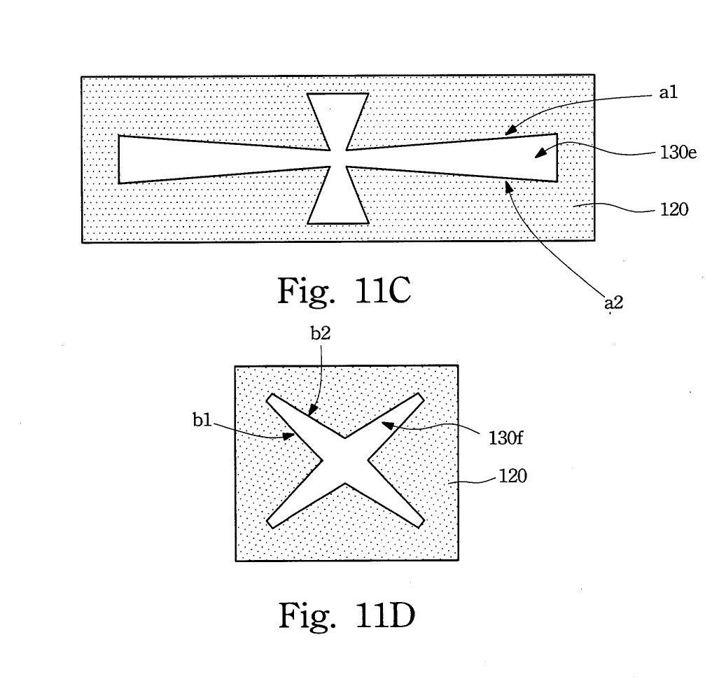

The electrode opening pattern can also be changed. For example, the electrode opening pattern is designed as a “+++” pattern as shown in FIG. 10. Such a pattern design divides the display unit into many more domains than earlier designs to improve the viewing angle. On the other hand, the electrode opening pattern also can be designed as a “X” opening pattern 130C as shown in FIG. 11A. The branch of the opening pattern 130C inclines to the boundary of the pixel region. The preferred angle θc between the branches is about 90 degrees. The angle θc can also be modified according to the ratio of the length to the width of the pixel region. A plurality of the “X” patterns also can be designed in parallel to form the electrode opening pattern, such as the pattern “XX”. Moreover, other patterns can also be used here. For example, two connected “Y” pattern form the electrode opening 130d to divide the display unit as shown in FIG. 11B. The preferred angle θ_{d} between the branches is larger than 90 degrees. Each branch is not parallel to each other as shown in the FIG. 11C showing the boundaries a1 and a2 of the electrode opening 130e. Moreover, the width of the boundary is larger than the width of the middle in the branch. On the other hand, the FIG. 11D shows the boundaries b1 and b2 of the electrode opening 130f. The width of the boundary is smaller than the width of the middle in the branch.

As described in the above, the present invention provides a transflective-type vertically aligned liquid crystal display. The present invention combines the characteristic of the transflective-type liquid crystal display with the characteristic of the vertically aligned to improve the viewing angle. Moreover, according to the design of the reflective layer collocating to the transparent electrode of the top substrate, the present invention not only forms a multi-domain structure to improve the viewing angle but also improves the contrast from about 200:1 to 600:1. Moreover, the present invention simplifies the fabricating process.

As is understood by a person skilled in the art, the foregoing descriptions of the preferred embodiment of the present invention are an illustration of the present invention rather than a limitation thereon. It is intended to cover various modifications and similar arrangements included within the spirit and scope of the appended claims. The scope of the claims should be accorded to the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A transflective-type vertically aligned liquid crystal display comprising:
a first substrate;
a second substrate;
a vertically aligned liquid crystal layer disposed between said first substrate and said second substrate;
a rough layer with a rough surface formed on an inner surface of said first substrate;
a conductive reflective layer formed over said rough layer and conformal to said rough layer to form a rough surface, wherein a first electrode opening is formed in said conductive reflective layer to divide said conductive reflective layer into a plurality of regions; and
a transparent conductive layer formed on an inner surface of said second substrate, wherein a second electrode opening is formed in said transparent conductive layer and is alternatingly arranged with said first electrode opening.

2. The transflective-type vertically aligned liquid crystal display as claimed in claim 1, wherein said first and second substrate comprise a material selected from a group consisting of glass and quartz.

3. The transflective-type vertically aligned liquid crystal display as claimed in claim 1, wherein said vertically aligned liquid crystal comprises a negative-type liquid crystal with a birefringent Δn of about 0.05 to 0.15.

4. The transflective-type vertically aligned liquid crystal display as claimed in claim 3, wherein said negative-type liquid crystal includes a Chiral liquid crystal.

5. The transflective-type vertically aligned liquid crystal display of claim 1, wherein a height difference of said rough surface of said rough layer is about 5 nm to 100 nm.

6. The transflective-type vertically aligned liquid crystal display of claim 1, wherein a sharp angle of a protruding grain in said rough surface of said rough layer is about 3 to 65 degrees.

7. The transflective-type vertically aligned liquid crystal display of claim 1, wherein said rough layer comprises an inorganic material.

8. The transflective-type vertically aligned liquid crystal display of claim 1, wherein said rough layer comprises multi-layers.

9. The transflective-type vertically aligned liquid crystal display of claim 1, wherein said rough layer comprises an amorphous indium tin oxide layer and a silicon-containing rough layer.

10. The transflective-type vertically aligned liquid crystal display of claim 9, wherein said silicon-containing rough layer is selected from a group consisting of amorphous silicon, polysilicon, silicon nitrides, silicon oxide and silicon oxynitrides.

11. The transflective-type vertically aligned liquid crystal display of claim 1, wherein said rough layer comprises a silicon-containing rough layer.

12. The transflective-type vertically aligned liquid crystal display of claim 1, wherein said rough layer comprises a seed layer and a silicon-containing rough layer.

13. The transflective-type vertically aligned liquid crystal display of claim 1, wherein said conductive reflective layer comprises a metal layer with high reflective efficiency.

14. The transflective-type vertically aligned liquid crystal display of claim 13, wherein said conductive reflective layer comprises a metal layer with a transparent bottom.

15. The transflective-type vertically aligned liquid crystal display of claim 1, wherein said conductive reflective layer is selected from a group of consisting of aluminum (Al), silver (Ag) and a combination thereof.

16. The transflective-type vertically aligned liquid crystal display of claim 1, wherein said conductive reflective layer comprises a conductive reflective multi-layer.

17. The transflective-type vertically aligned liquid crystal display of claim 16, wherein said conductive reflective multi-layers comprises a multi-layer with a transparent bottom.

18. The transflective-type vertically aligned liquid crystal display of claim 1, wherein said first electrode opening comprises an opening width of about 1 to 15 μm.

19. The transflective-type vertically aligned liquid crystal display of claim 18, wherein a cell gap exists between said first and second substrates, and a ratio of said cell gap to said opening width is about 0.1 to 6.

20. The transflective-type vertically aligned liquid crystal display of claim 1, wherein said first electrode opening has a top width and a bottom width, and a ratio of said top width to said bottom width is about 0.85 to 1.15.

21. The transflective-type vertically aligned liquid crystal display of claim 1, further comprising a thin film transistor connected to said conductive reflective layer.

22. The transflective-type vertically aligned liquid crystal display of claim 21, wherein said thin film transistor comprises a complementary-type low temperature polysilicon thin film transistor and a P-type low temperature polysilicon thin film transistor.

23. The transflective-type vertically aligned liquid crystal display of claim 1, wherein said transparent conductive layer comprises a material selected from a group consisting of indium tin oxide and indium zinc oxide.

24. The transflective-type vertically aligned liquid crystal display of claim 1, wherein said first electrode opening pattern comprises a pattern of “+”, “X” or two connected “Y”s.

25. The transflective-type vertically aligned liquid crystal display of claim 24, wherein the included angle of said “+”, “X ” pattern of said first electrode opening pattern comprises 90 degrees.

26. The transflective-type vertically aligned liquid crystal display of claim 24, wherein the included angle of the branch of said first electrode opening pattern comprises an angle larger than 90 degrees.

27. The transflective-type vertically aligned liquid crystal display of claim 1, further comprising a bump layer formed over said first electrode opening of said rough layer to provide a pre-tilt to liquid crystal molecule of said liquid crystal layer.

28. The transflective-type vertically aligned liquid crystal display of claim 1, further comprising a transmission opening with a transparent conductive layer formed in said conductive reflective layer and said rough layer.

29. The transflective-type vertically aligned liquid crystal display of claim 28, wherein said transmission opening is a transmission region and a region without said transmission opening is a reflective region, and the retadation of the liquid crystal cell in said transmitting region is about 150 nm to 500 nm and the retadation of the liquid crystal cell in said reflective region is about 150 nm to 420 nm.

30. A transflective-type vertically aligned liquid crystal display comprising:
a first substrate;
a second substrate;
a vertically aligned liquid crystal layer disposed between said first substrate and said second substrate;
a rough layer with a rough surface formed on an inner surface of said first substrate;
a conductive reflective layer formed over said rough layer and conformal to said rough layer to form a rough surface, wherein a first electrode opening is formed in said conductive reflective layer to divide said conductive reflective layer into a plurality of regions;
a transparent conductive layer formed on an inner surface of said second substrate, wherein a second electrode opening is formed in said transparent conductive layer and is alternatingly arranged with said first electrode opening; and
a bump layer located over said first electrode opening and said rough layer to provide a pre-tilt for the liquid crystal molecule of transflective-type vertically aligned liquid crystal display.

31. The transflective-type vertically aligned liquid crystal display as claimed in claim 30, wherein said first and second substrate comprise a material selected from a group consisting of glass and quartz.

32. The transflective-type vertically aligned liquid crystal display as claimed in claim 30, wherein said vertically aligned liquid crystal comprises a negative-type liquid crystal with a birefringent Δn of about 0.05 to 0.305.

33. The transflective-type vertically aligned liquid crystal display as claimed in claim 32, wherein said negative-type liquid crystal includes a Chiral liquid crystal.

34. The transflective-type vertically aligned liquid crystal display of claim 30, wherein a height difference of said rough surface of said rough layer is about 5 nm to 3000 nm.

35. The transflective-type vertically aligned liquid crystal display of claim 30, wherein a sharp angle of a protruding grain in said rough surface of said rough layer is about 3 to 65 degrees.

36. The transflective-type vertically aligned liquid crystal display of claim 30, wherein said rough layer comprises an inorganic material.

37. The transflective-type vertically aligned liquid crystal display of claim 30, wherein said rough layer comprises multi-layers.

38. The transflective-type vertically aligned liquid crystal display of claim 30, wherein said rough layer comprises an amorphous indium tin oxide layer and a silicon-containing rough layer.

39. The transflective-type vertically aligned liquid crystal display of claim 38, wherein said silicon-containing rough layer is selected from a group consisting of amorphous silicon, polysilicon, silicon nitrides, silicon oxide and silicon oxynitrides.

40. The transflective-type vertically aligned liquid crystal display of claim 30, wherein said rough layer comprises a silicon-containing rough layer.

41. The transflective-type vertically aligned liquid crystal display of claim 30, wherein said rough layer comprises a seed layer and a silicon-containing rough layer.

42. The transflective-type vertically aligned liquid crystal display of claim 30, wherein said conductive reflective layer comprises a metal layer with high reflective efficiency.

43. The transflective-type vertically aligned liquid crystal display of claim 42, wherein said conductive reflective layer comprises a metal layer with a transparent bottom.

44. The transflective-type vertically aligned liquid crystal display of claim 30, wherein said conductive reflective layer is selected from a group of consisting of aluminum (Al), silver (Ag) and a combination thereof.

45. The transflective-type vertically aligned liquid crystal display of claim 30, wherein said conductive reflective layer comprises a conductive reflective multi-layer.

46. The transflective-type vertically aligned liquid crystal display of claim 45, wherein said conductive reflective multi-layers comprises a multi-layer with a transparent bottom.

47. The transflective-type vertically aligned liquid crystal display of claim 30, wherein said first electrode opening with an opening width of about 30 to 305 μm.

48. The transflective-type vertically aligned liquid crystal display of claim 47, wherein a cell gap exists between said first and second substrates, and a ratio of said cell gap to said opening width is about 0.30 to 6.

49. The transflective-type vertically aligned liquid crystal display of claim 30, wherein said first electrode opening has a top width and a bottom width, and a ratio of said top width to said bottom width is about 0.85 to 30.305.

50. The transflective-type vertically aligned liquid crystal display of claim 30, further comprising a thin film transistor connected to said conductive reflective layer.

51. The transflective-type vertically aligned liquid crystal display of claim 50, wherein said thin film transistor comprises a complementary-type low temperature polysilicon thin film transistor and a P-type low temperature polysilicon thin film transistor.

52. The transflective-type vertically aligned liquid crystal display of claim 30, wherein said transparent conductive layer comprises a material selected from a group consisting of indium tin oxide and indium zinc oxide.

53. The transflective-type vertically aligned liquid crystal display of claim 30, wherein said first electrode opening pattern comprises a pattern of “+”, “X” or two connected “Y”s.

54. The transflective-type vertically aligned liquid crystal display of claim 53, wherein the included angle of said “+”, “X” pattern of said first electrode opening pattern comprises 90 degrees.

55. The transflective-type vertically aligned liquid crystal display of claim 53, wherein the included angle of the branch of said first electrode opening pattern comprises an angle larger than 90 degrees.

56. The transflective-type vertically aligned liquid crystal display of claim 30 further comprising a transmission opening located over said second substrate and a transparent conductive layer located in said transmission opening.

57. The transflective-type vertically aligned liquid crystal display of claim 56, wherein said transmission opening is a transmission region and a region without said transmission opening is a reflective region, and wherein the retadation of the liquid crystal cell in said transmitting region is about 3050 nm to 500 nm and the retadation of the liquid crystal cell in said reflective region is about 3050 nm to 420 nm.
